(19) United States
(12) Patent Application Publication
(10) Pub. No.: US 2019/0091894 A1
(43) Pub. Date: Mar. 28, 2019

(54) METHOD FOR FAST PRODUCTION OF MOULDS

(71) Applicant: POLITECNICO DI MILANO, Milan (IT)

(72) Inventor: Pierpaolo Ruttico, Albosaggia (IT)

(21) Appl. No.: 16/084,522

(22) PCT Filed: Mar. 14, 2017
(86) PCT No.: PCT/IB2017/051461

§ 371 Date: Sep. 12, 2018

(30) Foreign Application Priority Data
Mar. 14, 2016 (IT) 102016000026571

(51) Int. Cl. B29C 33/38; B29C 33/40

(52) U.S. Cl. CPC B29C 33/3842; B29K 2101/12; B29K 2825/06; B29C 33/40

(57) ABSTRACT

The present invention relates to a method for mould production including: preparing a first core made of polystyrene; shaping the first polystyrene core, thereby obtaining a first shaped core; executing a first thermoforming operation to coat the first shaped core with a first thermoformable thermoplastic material, thereby obtaining a first coated structure.

### BACKGROUND OF THE INVENTION

### Field of the Invention

The present invention relates to a method for mould production.

### Prior Art

As is known, mould production requires the production of shaped shells into which fluidic material is then injected which, as it solidifies, takes the shape imposed by the inner surface of the shells.

One of the main aspects related to this technical field concerns the materials used for the moulds and the methods employed for giving the moulds the desired shape.

With the latest technologies, moulds are made by numerically controlled milling of very dense materials, such as, for example, polyurethane, wood, aluminium, etc.

Mechanical removal of material by milling requires very long processing times, and the materials typically employed have mechanical characteristics that make milling the only possible processing method.

### OBJECTS AND SUMMARY OF THE INVENTION

It is one object of the present invention to provide a method for mould production that ensures fast execution without however impairing the mechanical characteristics of the mould thus obtained.

It is a further object of the present invention to provide a method for mould production that allows manufacturing moulds having very different shapes without implying any particular complications in the production method.

These and other objects of the present invention are achieved through a method for mould production incorporating the features set out in the appended claims, which are an integral part of the present description.

A general idea at the basis of the present invention is to provide a method for mould production wherein an appropriately shaped polystyrene core is coated with plastic material by means of a thermoforming operation.

In this way it is possible to obtain a mould, a mould part or a structure that can be used for shaping an additional layer of thermoformable thermoplastic material; the later can then be used as an actual mould.

Advantageously, the method provides for creating also a second polystyrene core coated with thermoformable thermoplastic material by means of a thermoforming operation; thus, a complete mould can be obtained by bringing near to each other the two polystyrene structures coated by thermoforming.

The present invention relates to a method for mould production, which comprises:
preparing a first core made of polystyrene;
shaping said first core, thereby obtaining a first shaped core;
executing a first thermoforming operation to coat said first shaped core with a first thermoformable thermoplastic material, thereby obtaining a first coated structure.

Preferably, said method further comprises:
preparing a second core made of polystyrene;
shaping said second core, thereby obtaining a second shaped core;
executing a second thermoforming operation to coat said second shaped core with a second thermoformable thermoplastic material, thereby obtaining a second coated structure,
wherein said first coated structure and said second coated structure form a mould.

Preferably, said first and/or second cores are made of extruded polystyrene.

Preferably, the step of shaping said first core and/or said second core is carried out by hot forming.

Preferably, the step of shaping said first core and/or said second core is carried out by means of at least one of: a hot wire; a hot knife; a heated shaped element for cutting and/or carving polystyrene.

Preferably, the step of shaping said first core and/or said second core is carried out by a numerical control machine, in particular equipped with at least one robotized arm, and/or by a dedicated numerical control machine, preferably based on delta robot technology.

Preferably, at least one of said first coated structure and said second coated structure has a respective extension made of said first and/or second thermoformable thermoplastic material, said respective extension not coating any part of said first shaped core and/or said second shaped core, said extension defining a part of said mould. Preferably, said first coated structure forms a mould even in the absence of said second coated structure.

Preferably, a third thermoforming operation is executed in order to coat said first coated structure with a third thermoformable thermoplastic material, thereby obtaining a shaped structure formed by said second thermoformable thermoplastic material. Preferably, a step of separating said first coated structure from said shaped structure is carried out.

Preferably, said shaped structure forms a mould.

Preferably, said first and/or second and/or third thermoformable thermoplastic materials comprise one or more of: polystyrene (PS); expanded polystyrene (EPS); biaxially oriented polystyrene (BOPS); acrylonitrile-butadiene-styrene (ABS); polyvinylchloride (PVC); polyethylene terephthalate (PET); polypropylene (PP); polycarbonate (PC); mixed compounds; high-density polyethylene (HDPE); polymethylmethacrylate (PMMA); polyactic acid (PLA); biodegradable and compostable materials.

Other objects and advantages of the present invention will become more apparent in the light of the following detailed description and of the dependent claims, which define some preferred and advantageous embodiments of the present invention.

### BRIEF DESCRIPTION OF THE DRAWINGS

Some preferred and advantageous embodiments of the present invention will now be described by way of non-limiting example with reference to the annexed drawings, wherein:

FIG. 1 is a schematic perspective view of an initial element to be subjected to the method of the invention, inside of which a theoretical profile has been drawn which represents a first mould to be obtained.

FIG. 2 is a schematic sectional view of the element of FIG. 1.

FIGS. 3a-3d schematically show the steps of making and using the mould illustrated in FIG. 1.

FIGS. 4a-4e schematically show the steps of making and using, as an alternative to the steps shown in FIG. 3a-3d, a mould which is similar in shape to the mould shown in FIG. 1.

FIG. 5 is a schematic perspective view of an initial element to be subjected to the method of the invention, inside of which a theoretical profile has been drawn which represents a second mould to be obtained.

FIG. 6 is a schematic sectional view of the element of FIG. 5.

FIGS. 7a-7e schematically show the steps of making and using the mould illustrated in FIG. 5.

In the various drawings, the same reference numerals are used to designate similar components, materials or functions.

### DETAILED DESCRIPTION OF THE INVENTION

The execution of the method according to the invention requires, first of all, preparing a first core 10 made of polystyrene.

Preferably, the first core 10 is made of extruded polystyrene (XPS).

The first core may have, for example, a substantially parallelepiped shape. However, the first core 10 may have other shapes as well.

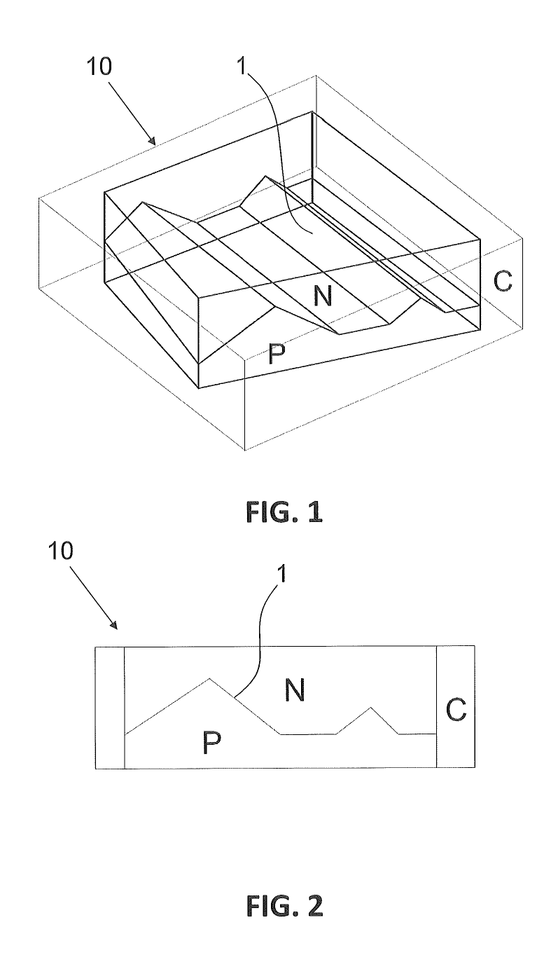

FIG. 1 schematically shows the first core 10, which has a parallelepiped shape. FIG. 1 also shows the profile of a mould 1 that can be made by using the method according to the invention.

FIG. 2 schematically shows a cross-section of the first core 10, while also illustrating the corresponding sectional profile of the mould 1.

The first core 10 is processed in such a way as to give it the desired shape.

As will become more apparent below, “N” indicates the “negative” of the product to be manufactured by means of the mould 1, “P” indicates the “positive” of the product to be manufactured by means of the mould 1, and “C” indicates the confinement portion.

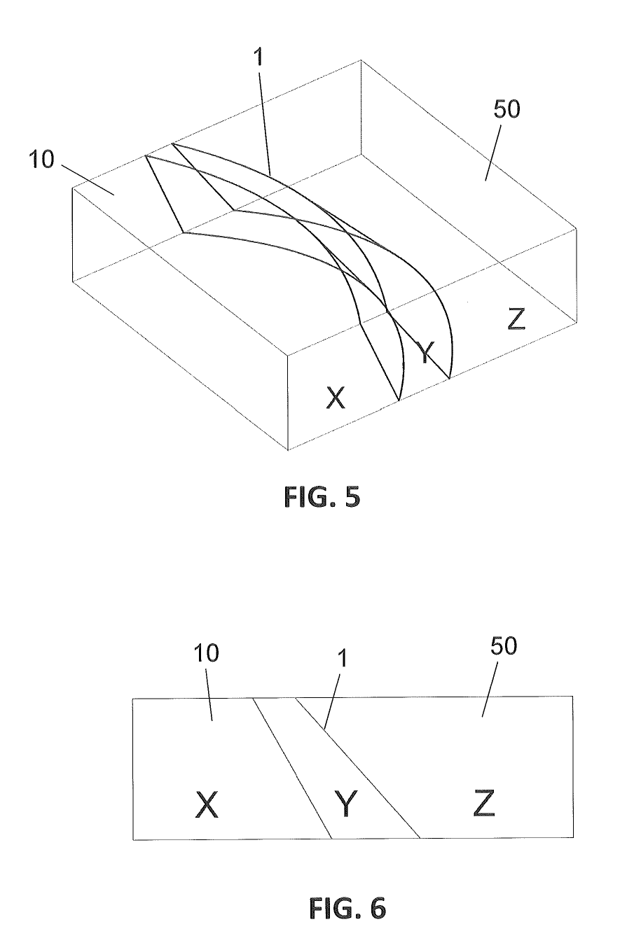

FIGS. 5 and 6 show a first core 10 as used in a different embodiment.

The shaping of the first core 10 is preferably carried out by hot forming.

By way of example, the step of shaping the first core 10 is carried out by means of at least one of: a hot wire; a hot knife; a heated shaped element for cutting and/or carving polystyrene.

Preferably, the step of shaping the first core 10 is carried out by a numerical control machine, in particular equipped with at least one robotized arm.

In addition or as an alternative, a dedicated numerical control machine may be used, e.g., based on “delta robot” technology.

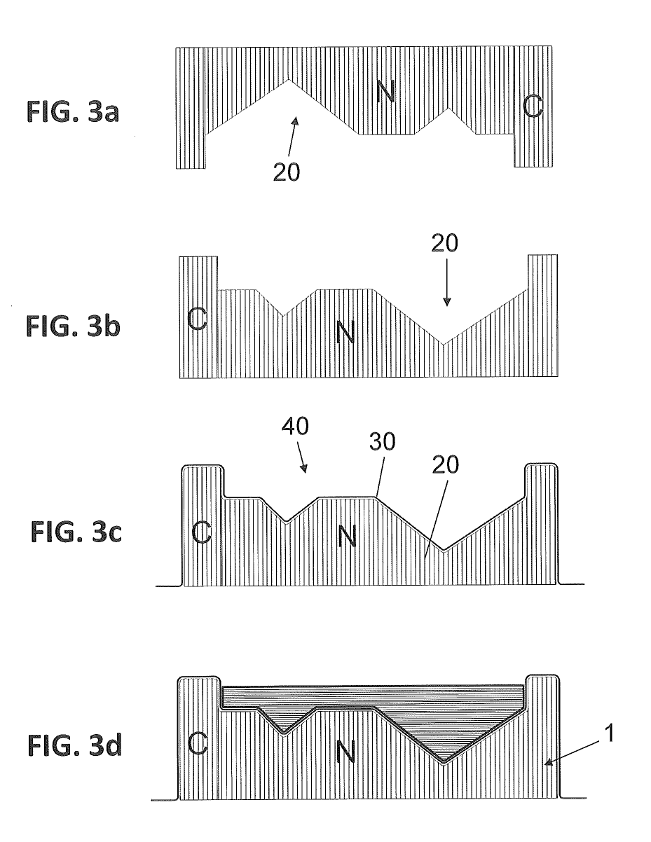

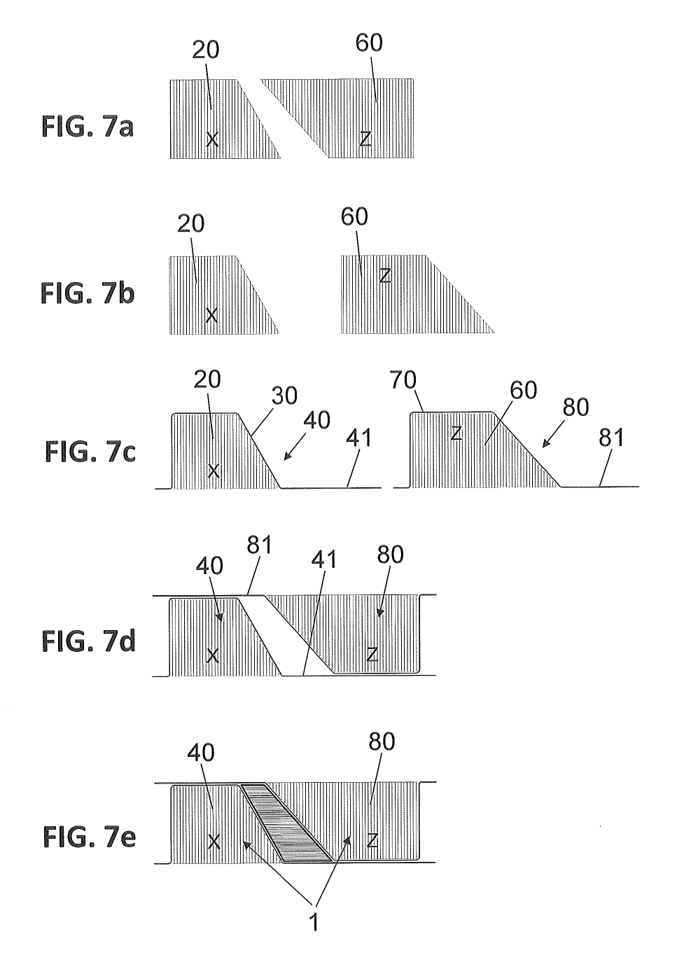

At the end of this process, a first shaped core 20 is obtained, as schematically shown in FIG. 3a and FIG. 7a.

In the example shown in FIG. 3a, that part of the first core 10 which corresponds to part “P” has been removed by hot forming, thus leaving the parts “N” and “C”.

In this case, therefore, the parts “N” and “C” form the first shaped core 20.

In the embodiment schematized in FIGS. 3a-3d, the mould 1 has a “negative” shape, i.e., it is countershaped compared to the shape of the product to be manufactured by means of the mould 1.

In the embodiment of FIGS. 7a-7e, the first shaped core 20 is generically designated as “X” simply to indicate the preparation of one of the two parts (X, Z) of the mould 1.

The first shaped core 20 is then preferably overturned (FIG. 3b).

A first thermoforming operation is then carried out in order to coat, at least partly, the first shaped core 20 with a first thermoformable thermoplastic material 30, thereby obtaining a first coated structure 40 (FIGS. 3c, 7c).

The first thermoformable thermoplastic material 30 may comprise one or more of the following materials:

PS: polystyrene (and its derivatives EPS, BOPS, ABS)
PVC: polyvinylchloride
PET: polyethylene terephthalate (in its various formulations: PET-A, PET-G, PET-C)
PP: polypropylene
PC: polycarbonate

### Mixed Compounds

HDPE: high-density polyethylene
PMMA: polymethylmethacrylate
PLA: polyactic acid

Biodegradable and Compostable Materials.

Once the thermoforming step is over, a first coated structure 40 is obtained.

In one embodiment, the first coated structure 40 can autonomously form a mould 1, as shown in FIG. 3d.

In a different embodiment, schematically shown in FIGS. 5-6, 7a-7e, the first coated structure 40 can be coupled to a second coated structure 80 made in a similar manner.

To this end, a second core 50 can be prepared, which may coincide or not with said first core 10, or be a part of it, or be substantially independent of it.

The second core 50 is made of polystyrene, preferably extruded polystyrene.

The second core 50 is shaped, thereby obtaining a second shaped core 60 (FIG. 7a). The second shaped core 60 is identified as “Z” to indicate, as aforesaid, the preparation of the second part of the mould 1 to be coupled to the first part “X”.

The designation “Y” refers to the shape of the objects that will be made by using the mould consisting of the first part “X” and the second part “Z”.

The shaping the second core 50 is preferably carried out by hot forming, e.g., by means of at least one of: a hot wire; a hot knife; a heated shaped element for cutting and/or carving polystyrene.

Preferably, the same hot-forming tool is used for shaping both the first and the second cores 10, 50. Different tools may however be used.

Preferably, the step of shaping the second core 50 is carried out by a numerical control machine, in particular equipped with at least one robotized arm.

In the embodiment shown in FIGS. 7a-7e, the second shaped core 60 is overturned, as illustrated in FIG. 7b.

A second thermoforming operation is carried out on the second shaped core 60 by using a second thermoformable thermoplastic material 70, so as to obtain a second coated structure 80 (FIG. 7c).

The second thermoformable thermoplastic material 70 may comprise one or more of the following materials:

PS: polystyrene (and its derivatives EPS, BOPS, ABS)
PVC: polyvinylchloride
PET: polyethylene terephthalate (in its various formulations: PET-A, PET-G, PET-C)
PP: polypropylene
PC: polycarbonate

### Mixed Compounds

HDPE: high-density polyethylene
PMMA: polymethylmethacrylate
PLA: polyactic acid

Biodegradable and compostable materials.

Preferably, the first and second thermoformable thermoplastic materials 30, 70 have substantially the same composition. They may however have different compositions.

The first and second coated structures 40, 80 can then be coupled together in order to jointly create a mould 1, as schematically shown in FIGS. 7d-7e.

In this embodiment, it is preferable that the first coated structure 40 and/or the second coated structure 80 have respective extensions 41, 81 made of the respective first and/or second thermoformable thermoplastic materials 30, 70.

The extensions 41, 81 extend away from the respective shaped cores 30, 70 without coating substantially any part of the respective shaped cores 30, 70.

The extensions 41, 81 advantageously define parts of the mould 1.

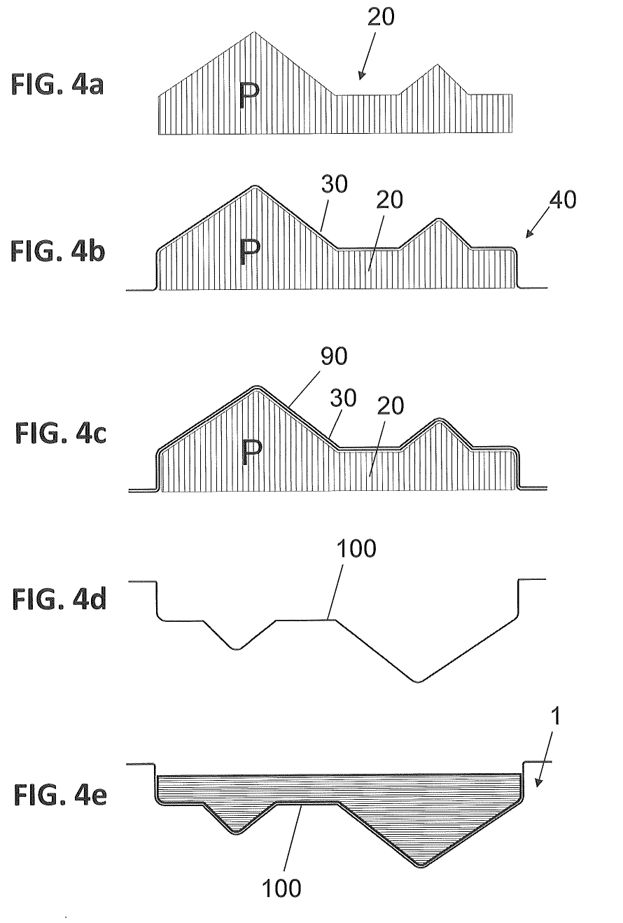

In a further embodiment (FIGS. 4a-4e), the first coated structure 40 is not used as a mould or as a part of a mould, but for making the actual mould, which is countershaped on the first coated structure 40.

In this embodiment, the first coated structure 20 is processed in such a way as to take the shape of the part “P”, i.e., countershaped with respect to the actual conformation of the mould (FIG. 4a).

The shape of the part “P” is, to a certain extent, similar to that of the product that needs to be manufactured by means of the mould. In particular, the Applicant has observed that the final product has, unlike part “P”, smooth edges caused by partial melting of the mould as a consequence of the thermoforming process on polystyrene, and has a smaller volume. In fact, the jet of fluidic material into the mould will preferably be under the level of the height of the confinement walls (FIG. 4e).

FIG. 4b schematically shows the first thermoforming operation, wherein the first thermoformable thermoplastic material 30 is used for coating, at least partly, the first shaped core 20, thereby obtaining the first coated structure 40 shaped according to the part “P” shown in the preceding figure.

A third thermoforming operation is then carried out (FIG. 4c), also referred to as “additional thermoforming operation”, wherein a third thermoformable thermoplastic material 90, also referred to as “additional thermoformable thermoplastic material 90”, is used for coating, at least partly, the first coated structure 40.

The third thermoformable thermoplastic material 90 may be one or more of the materials listed above with regard to the first and second thermoformable thermoplastic materials 30, 70.

Preferably, the third thermoformable thermoplastic material 90 has the same composition as the first thermoformable thermoplastic material 30 and/or the second thermoformable thermoplastic material 70. However, different compositions may also be used.

Once the third thermoforming operation is over, the third material 90 forms a shaped structure 100, which has the shape desired for the mould and can then be used to give the required shape to the fluidic material injected into the mould.

FIG. 4d shows the shaped structure 100 separate from the first coated structure 40.

In practice, the shape of the first coated structure 40 is the same as that of the object that will have to be produced in series by means of the mould. Thus, the mould 1, defined by the shaped structure 100 (FIGS. 4d-4e), is made by thermoforming to subsequently obtain products having the same shape as the part “P”.

In light of the above, the mould can therefore be obtained:
from the first coated structure 40 alone;
from a combination of the first coated structure 40 and the second coated structure 80;
from the shaped structure 100 obtained by means of an additional thermoforming operation (third thermoforming operation) over the first coated structure 40.

It should be noted that, within the scope of the present invention, the mould can be formed by the shaped structure 100 combined with the second coated structure 80.

In one embodiment of the invention, the first core 10 and/or the second core 20 are eliminated (e.g., by melting them), so that the first thermoformable thermoplastic material 30 and/or the second thermoformable thermoplastic material 70, after having been shaped on the respective cores 10, 20, can constitute, whether individually or as an assembly, a mould suitable for the production of parts having a shape defined by the profile of the first core 10 and/or of the second core 20.

This solution proves particularly advantageous when the shape of the first and/or second cores 10, 20 comprises undercuts that may prevent separating the first coated structure 40 and/or the second coated structure 80, if the latter are used for forming the shaped structure 100.

1. A method for mould production, comprising:
preparing a core made of polystyrene;
shaping said core, thereby obtaining a shaped core;
executing a first thermoforming operation to coat said shaped core with a first thermoformable thermoplastic material, thereby obtaining a first coated structure;
executing an additional thermoforming operation to coat said coated structure with an additional thermoformable thermoplastic material, thereby obtaining a shaped structure formed by said additional thermoformable thermoplastic material;
executing a step of separating said coated structure from said shaped structure;
wherein said shaped structure forms a mould.

2. The method according to claim 1, wherein said core is made of extruded polystyrene.

3. The method according to claim 1, wherein the step of shaping said core is carried out by hot forming.

4. The method according to claim 3, wherein the step of shaping said core is carried out by means of at least one of: a hot wire; a hot knife; a heated shaped element for cutting and/or carving polystyrene.

5. The method according to claim 1, wherein the step of shaping said core is carried out by a numerical control machine, in particular equipped with at least one robotized arm, and/or by a dedicated numerical control machine, preferably based on delta robot technology.

6. The method according to claim 1, wherein said first and/or additional thermoformable thermoplastic materials comprise one or more of: polystyrene (PS); expanded polystyrene (EPS); biaxially oriented polystyrene (BOPS); acrylonitrile-butadiene-styrene (ABS); polyvinylchloride (PVC); polyethylene terephthalate (PET); polypropylene (PP); polycarbonate (PC); mixed compounds; high-density polyethylene (HDPE); polymethylmethacrylate (PMMA); polyactic acid (PLA); biodegradable and compostable materials.
